(19) United States
(12) Patent Application Publication
(10) Pub. No.: US 2005/0091113 A1
(43) Pub. Date: Apr. 28, 2005

(54) System and method for implementing HACCP process and control at a plurality of food service establishments via the internet

(75) Inventors: Malcolm L. Mitchell, San Diego, CA (US); Jeffery L. Warren, San Diego, CA (US)

Correspondence Address: Crockett & Crockett, 24012 Calle De La Plata, Suite 400, Laguna Hills, CA, 92653, US

(73) Assignee: IQ Scientific Instruments, Inc.

(21) Appl. No.: 10/693,465

(22) Filed: Oct. 24, 2003

(51) Int. Cl. G06F 17/60

(52) U.S. Cl. 705/15

(57) ABSTRACT

A system and method for implementing HACCP process and control at a plurality of food service establishments via the Internet. A HACCP system administrator establishes the parameters of the HACCP system for the overall organization. The parameters, once defined, are thereafter visible at each remote facility within the organization. Food service workers make observations and enter data into a PDA where they are thereafter uploaded and stored in a database server.

### FIELD OF THE INVENTION

The inventions described below relate to the field of food safety administration for controlling the hygiene or safety of Food Service Establishments.

### BACKGROUND OF THE INVENTION

HACCP (Hazard Analysis Critical Control Point) is an internationally accepted technique used in the food service industry for preventing microbiological, chemical and physical contamination along the food supply chain. The HACCP technique does this by identifying potential hazards associated with a food, establishing critical control points in a food's production, setting critical limits for each control point, establishing procedures to monitor the critical control points, establishing corrective actions to be taken when monitoring shows that a critical limit has not been met, establishing procedures to verify that the system is working properly, and establishing effective record keeping to document the HACCP system.

Every restaurant that uses a HACCP system is required to maintain and control test data records. For example, a restaurant employee daily checks various critical control points in a food's production, including the food's temperature, storage temperature, pass or failure data, etc. The employee then fills out a paper checklist recording the data. These paper checklists are required for each food item as well as checklists for other potential hazards associated with food. Where a multitude of restaurants are affiliated with an organization, and each restaurant has its own checklists, an enormous amount of paperwork can be generated.

In addition to the mountains of paperwork generated by this manual procedure, the data is difficult if not impossible to process. Currently, operators do not know what the appropriate corrective actions are when a measurement is outside the critical limit. Furthermore, restaurant employees making the observations do not always follow standard procedure, often sitting in a back office filling out a checklist without actually observing the required checklist items.

### SUMMARY

The HACCP system described below provides for a web-based architecture, making the system readily deployable in large organizations. The HACCP system administrator establishes the parameters of the HACCP system for the overall organization. The parameters, once defined, are thereafter visible at each remote facility within the organization. HACCP input operators make observations and enter data into a HACCP predetermined checklist. Data is entered into a computer device and the checklists presented on the screen completed electronically. When a critical limit is violated, corrective action prompts appear directly on the screen of a personal digital assistant handheld computer (PDA) for the input operator to follow. The HACCP software program, parameters, and data results are stored in a database server. Changes to checklist forms, critical limits, and corrective actions instantly propagate company-wide.

The direct temperature input from the integrated probe minimizes error. An integrated data reader embedded on the probe reads coin-sized metal tags, each with a unique I.D. These tags can be used to ensure that users make observations in the required location. In addition, the data reader can download information from data loggers placed throughout the facility, as well as any critical control point in a food's production cycle.

The system manages complex multi-step processes such as cooling by providing for checklists within checklists. Alarms, elapsed time timers, and different critical limits and corrective actions at each point manage and document multi-step processes. Real time corrective action prompts appear when potential problems are detected.

### BRIEF DESCRIPTION OF THE DRAWINGS

FIG. 1 shows an overview of the system components.

FIGS. 2a through 2x illustrate sample screen shots of the user interface for the HACCP administrator.

FIG. 3 shows one implementation of the system described in FIG. 1.

FIG. 4 shows one embodiment for a temperature probe with embedded data reader.

### DETAILED DESCRIPTION OF THE INVENTION

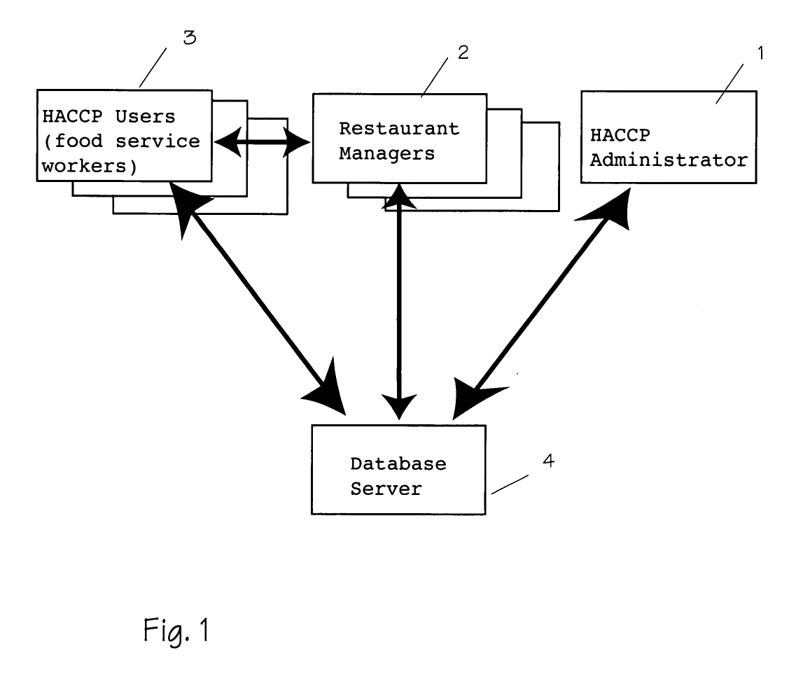

FIG. 1 shows an overview of the HACCP system, comprising a HACCP system administrator 1, restaurant managers 2 and HACCP input operators or “users” 3. The HACCP system administrator, in concert with the organization's HACCP goals, establishes the parameters of the HACCP system for the overall organization. The HACCP system administrator accomplishes the task of defining the system parameters by way of a personal computer or other computing device with access to the Internet. An elaborate user interface is provided for initially setting up and managing the rules and configuration of the HACCP system. The program and parameters are stored in a database server 4, either resident in the HACCP administrator computer or elsewhere at a remote database server accessible via the Internet. The parameters, once defined, are thereafter visible at each remote facility within the organization. The HACCP administrator may make changes to the parameters at any time when a change or revision is required to be implemented throughout the organization. The HACCP administrator may program the parameters from any location: at corporate headquarters, at a remote facility, even from a laptop computer anywhere in the world. Four main parameters are used: locations, items, users, and checklists.

First, the HACCP administrator creates a list of locations where HACCP inputs and measurements will be required. “Location” generally refers to a specific location (such as a restaurant) or a group of locations (such as a region). As such, locations are defined hierarchically. “Location” may also refer to critical control points in a particular restaurant, such as the kitchen, buffet or food cart. Location details, such as name and address, are entered. Finally, location contact information, such as a restaurant manager's name, telephone and fax numbers and email address are added. The information is stored in the database server 4 where it is maintained until it is subsequently edited, deleted or new locations added.

The HACCP administrator then creates a list of items where HACCP inputs and measurements will be required. An “item” may be a menu item, such as a hamburger, a piece of equipment, such as a grill, or a general food safety process, such as use of protective gear. Item details are then entered, such as name (hamburger) and description (all hamburgers). Item “parents” may also be entered, such as “beef.” Processes associated with the item are entered as applicable, such as cooking, reheating, freezing, cold handling, or hot handling. Process measurements, such as temperatures, may be added, edited or deleted. Corrective actions may also be added to dictate actions to be taken in the event of a violation, such as a time-out violation or out of specification temperature. The item list may be filtered based upon available location menu items, for example, if a particular food item is not available at all of the organization's locations. Items can thereafter edited, deleted or added.

The HACCP administrator also creates a list of users. User details, such as user's name, telephone, and email address, Internet user id, and web password or personal identification number (PIN) are entered. Some users will be able to access computer input devices and those users will have a special password allowing them access to the input device. Information for existing users can be edited, such as a change to telephone number or email address, Internet access information and input device access information. The list of users is maintained until it is subsequently edited.

Finally, the HACCP administrator creates the checklists (or assigns predetermined checklists). Data is entered for each checklist, such as its category, description, the time the checklist is to be performed, and the checklist item's execution cycle, such as daily, weekly, or other. Checklist categories include such duties as cooking, cooling, cold holding, hot holding, reheating, etc. Checklist activities can be scheduled or unscheduled. Checklist categories can contain one or more sub-checklists. A provision may be added so that notes can also be entered into the checklists. A list of checklist items may be programmed in advance and selected by the HACCP administrator to add to the checklist.

Several checklist item types are used in the system, such as text, choice, measurement, or process. If the checklist item type is a “text,” then the operator adds checklist item details as text entry. If the checklist item type is a “choice,” then the operator selects from two or more choices presented on the handheld computer. If the “wrong” answer is selected, the operator is presented with appropriate corrective actions defined by the HACCP administrator. If the checklist item type is a “measurement,” then the operator inputs a measured value, such as temperature, either manually or through the use of the integrated temperature probe. If the measured value is out of specification, then the operator is presented with appropriate corrective actions. A corrective action might be to discard food or contact the manager. If the checklist item type is a “process,” then the item inherits process rules. For example, a process rule might exist for the cooking of any ground beef product to a temperature of 150 degrees Fahrenheit. If a process type checklist item was “Check the temperature of a hamburger,” this item would automatically inherit a cooking temperature rule of 150 degrees Fahrenheit by virtue of being a ground beef product. Checklists may be reordered in any order desirable by the HACCP administrator. The checklists are maintained until they are subsequently edited.

The restaurant managers supervise the food service workers and make additional changes and recommendations to checklists established at the corporate level by the system administrator. Restaurant managers are restricted in the changes that they can make to the overall system checklists. For example, it is likely that the HACCP administrator would configure the software to allow the restaurant manager to access the user information to update employee information, add and delete employees as necessary, and also reflect special access to different procedures depending on employee promotions and shift changes. It is not likely that the HACCP administrator would configure the software to allow the restaurant manager to access parameters relative to critical control points, such as making a substantive change to the checklist procedures.

Once the HACCP parameters have been entered by the HACCP system administrator and stored in the database server 4, users will start to enter data into the system. The user will enter data into a data acquisition system. The data entered into the data acquisition system will be uploaded to the database via the Internet when synced with the restaurant manager's personal computer.

HACCP input operators are food service workers tasked with the HACCP function of taking readings and entering data into a HACCP predetermined checklist. Data is entered into a data acquisition system and the checklists presented on the screen completed electronically. In the preferred embodiment, the data acquisition system includes a personal digital assistant (PDA) or other hand held computer device. However, a laptop or other personal computer could be used. The user follows a series of beeps and prompts to follow the checklist.

The data acquisition system also includes various probes. Primarily, a temperature probe is provided for use in making temperature measurements, which are the predominant parameter of HACCP. The temperature probe is ideally connected directly to the PDA for ease in taking measurements and logging the information directly into the PDA to avoid user error in inputting data.

Small tags, each with a unique digital ID are also employed. By affixing ID tags such as the iButton® at various locations in a facility it is possible to determine the exact location of the operator when a check was performed. For example, ID tags can be attached to freezer walls, lavatory walls, or any place where the user will have to make a reading. This insures that the operators are actually where they are supposed to be when performing checks and are not simply sitting in a back office filling out a checklist. ID tags may also have data logging capability. Data logging ID tags, such as the Thermochron®, can be mounted in refrigerators, freezers, or go wherever thermally vulnerable products go, monitoring time and temperature and storing the data. Data loggers easily attach to a container, recording time and temperature during transport and storage. By logging the thermal experience of temperature-sensitive material, HACCP administrators can pinpoint responsibility for spoilage and take corrective action. The data logger reader, or ID tag reader, is built into the temperature probe and reads the unique ID number from iButton® tags or captures the temperature data from the Thermochron® data logger tags. The temperature probe with built-in tag reader can be attached to the PDA, the user's computer, or any other device for ease of retrieving the information.

The series of steps and figures described below reflect one of the many embodiments for implementing a HACCP system via the Internet. Many other screens and procedures may be implemented, depending on the organization's HACCP goals. The user inputs reflect a system already set up by the HACCP administrator, as previously described.

In general, an operator pushes a single button to hot sync the PDA, and in just a few seconds, the most current HACCP data for that restaurant is automatically downloaded via the Internet. Process rules, checklists, food items, equipment lists, critical limits, corrective actions and more are all quickly loaded onto the PDA. Thereafter, the operator follows prompts—flashing icons and audible alarms that alert the operator when it is time to perform checks. A temperature probe captures temperature data directly to the PDA. A built-in tag reader verifies that operators are actually where they are supposed to be when performing checks. Operators document that they actually are where they are supposed to be when performing checklists by touching coin sized metal tags. At the end of the day, an operator pushes the button again, and all the data is sent via the Internet to a central database. Reports can be viewed by management anywhere via the Internet.

Login

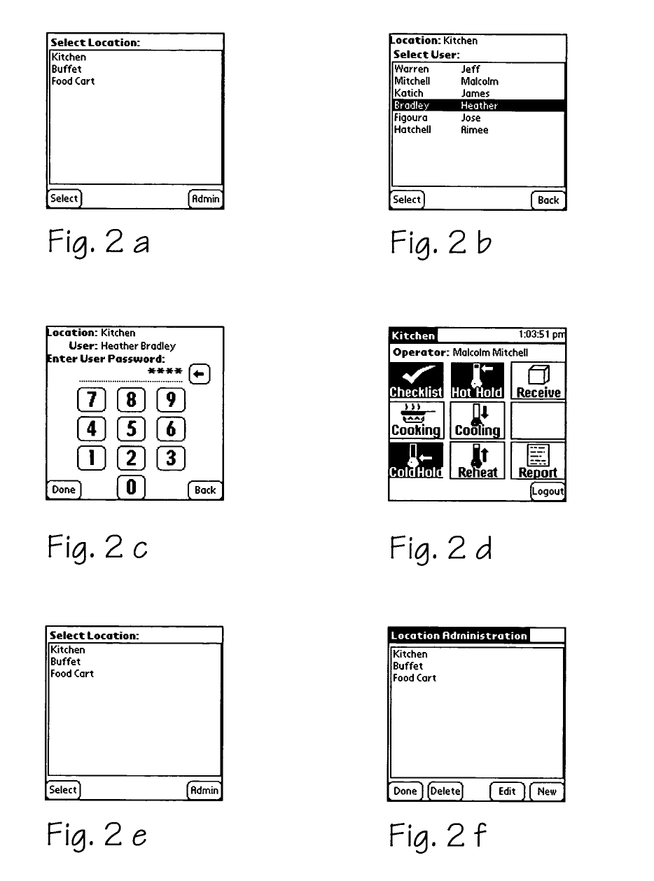

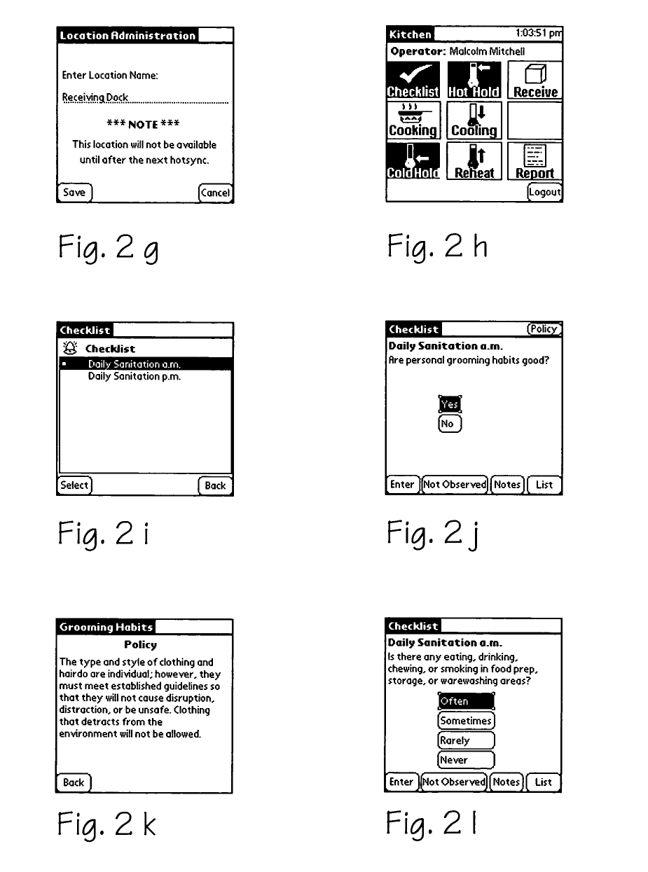

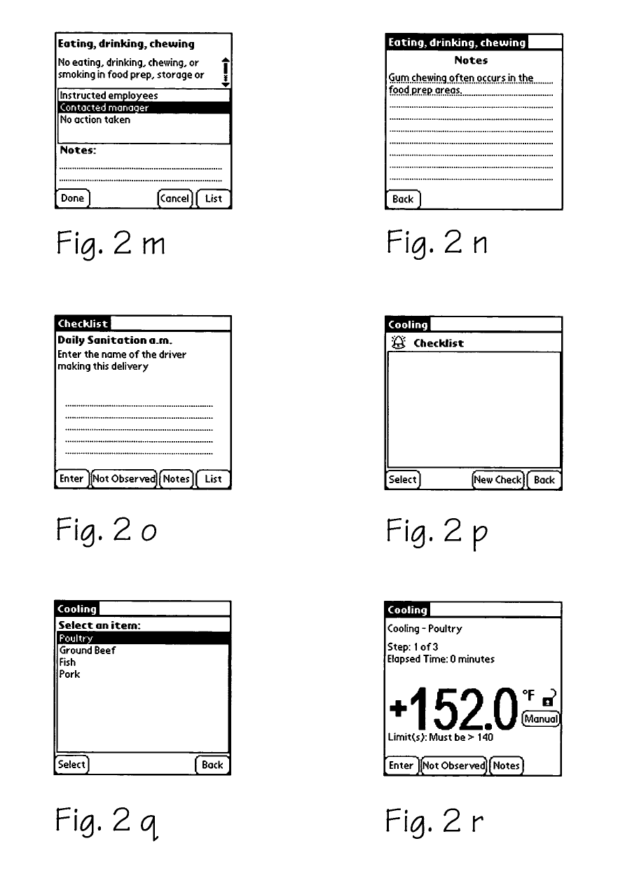

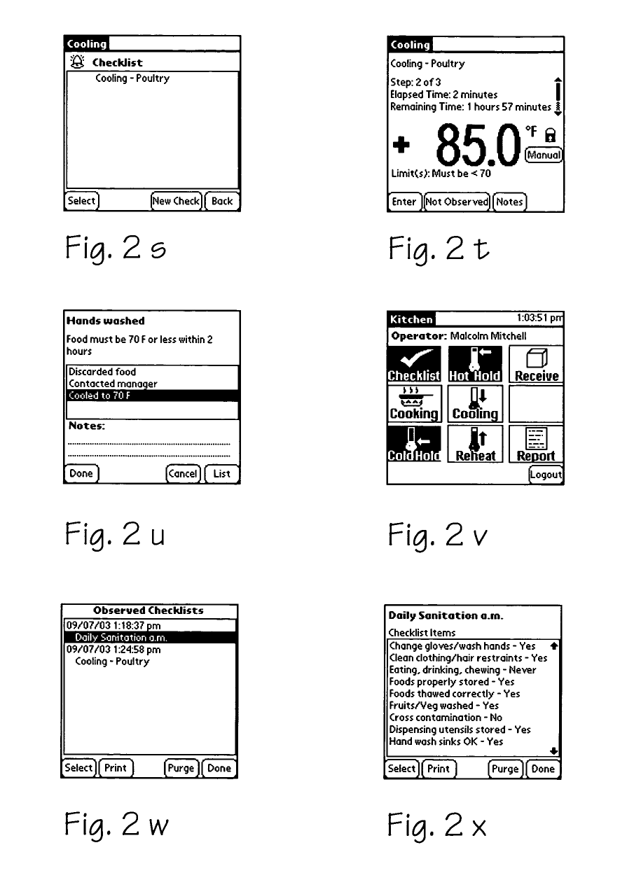

When the application on the PDA is first launched, the user will be presented with a list of locations that have currently been defined for use by this PDA. As shown in FIG. 2a, the users of this input device will be entering data relative to the kitchen, buffet and food cart site locations. Each location in the list can have its own unique set of users, checklists, and menu and equipment items.

After selecting a location, the list of users authorized to use the PDA at that location will be presented to the user, as shown in FIG. 2b. After selecting a user and keying in the user's personal identification number (PIN) (see FIG. 2c), the main application screen is available (see FIG. 2d).

Location Administration by Restaurant Manager

PDAs can be difficult to uniquely identify, and can break and need to be replaced. Therefore, the restaurant manager can program “locations” directly into the PDA rather than requiring the intervention of the HACCP system administrator. Pressing the Admin button on the Select Location screen (FIG. 2e) directs the user to the Location Administration screen (FIG. 2f). From the Location Administration screen (FIG. 2f), locations to associate with this PDA can be added, deleted, and edited. FIG. 2g shows an example of defining a new location for this PDA. Once the new location name is entered, the PDA can download the associated items, users and checklist parameters from the database server 4.

Checklist Execution

Whenever a checklist is scheduled for execution, and a user is logged into the PDA, the PDA application will automatically wake itself up, emit an audible alarm, and flash the icon on the main application screen to indicate the checklists that a user must address and complete in order to comply with the HACCP procedure governed by the checklist. FIG. 2h indicates that one or more checklists in the Checklist, Hot Hold, and Cold Hold categories need attention.

Checklists may govern scheduled or unscheduled checklists. Unscheduled checklists are used for storing infrequently used checks, or ones that only need to be executed as part of standard operating procedures under particular circumstances (for example, only when a particular piece of equipment is in use or when a particular evolution is in progress). Each of the checklist categories shown on the main screen can contain one or more checklists. Clicking on an icon from the main screen (FIG. 2h) shows the sub-checklists for that category.

FIG. 2i shows a list of checklists in the “Checklist” category for a particular PDA. In this case, the bullet next to the “Daily Sanitation a.m.” checklist indicates that that checklist is currently “alarming” and needs to be executed. A checklist is executed by simply selecting it from the list.

Each question on a checklist will be presented to the user one at a time. FIG. 2j shows a sample question from the “Daily Sanitation a.m.” checklist. In this particular case, the question has a possible response of yes or no. There can be occasions when the HACCP system administrator wants to provide additional information regarding the policy that should be used for determining the proper response to the question. The question shown in FIG. 2j has a policy associated with it that can be viewed by clicking on the “Policy” button in the upper right corner of the screen. This will present the user with the Policy screen as shown in FIG. 2k.

“Choice” questions can have up to four possible responses in this example. FIG. 2l shows a question from the Daily Sanitation a.m. checklist that has four possible responses. Each choice can optionally have its own set of corrective actions associated with it. These corrective actions are presented to the user to indicate that the response that was selected requires immediate action to be taken, and provides a mechanism for including with the report the corrective action that was taken. FIG. 2m below shows the set of corrective actions that are presented to the user if the “Often” answer is selected to the question posed in FIG. 2l.

The user can also enter in notes to be associated with the answer to individual questions on a checklist. FIG. 2n shows a sample notes screen that could be entered by clicking on the Notes button in FIG. 2l.

FIG. 2o shows an example of a “text” question. A text question is one that does not have a multiple-choice set of answers to select, but instead requests that a piece of text be entered as a response. Note also that all questions within a checklist have an option of selecting the “Not Observed” button. This allows questions to be skipped that are either currently irrelevant, or cannot be answered for other reasons, such as an observation for a piece of equipment that is down for maintenance.

Process Execution

In addition to executing checklists as a form of predefined questions, the PDA application supports monitoring processes that have defined critical limits for multiple-step processes. The rules for a particular process and item are configured by the HACCP system administrator. To execute a process, after selecting the category for the process from the main screen, click on the “New Check” button as shown on FIG. 2p. In this example, the list of items configured for this location that can be cooled are presented to the user for selection, as shown in FIG. 2q. After selecting the item, the user will be presented with a temperature measurement screen for the first step in the process (FIG. 2r). Note that the critical limits for this step will be displayed below the real-time temperature indicator.

After the first step for a process has been executed, subsequent steps in the process can be executed by reselecting the item. In the example above, from the main screen, the Cooling category would be selected, and the Poultry item that has already started to cool will be available from the list as shown in FIG. 2s. Selecting this item from the list will present the temperature measurement screen for the second step in the process, as shown in FIG. 2t. Note that the critical limits that are displayed were entered by the HACCP system administrator as appropriate for this step in the process. If a value is entered that does not meet the critical limits, a set of corrective actions will be presented as shown in FIG. 2u. The process is completed once all of the steps have been performed.

Reviewing Checklists

After a checklist has been executed, the results are stored in memory until they are purged or written-over. The answers for a particular checklist can be reviewed and modified anytime before they are purged or written-over. To start this process, the user clicks on the Report button from the main screen as shown in FIG. 2v. This feature may be disallowed by the system administrator.

The list of checklists that have been executed on this PDA will be shown in a list as shown in FIG. 2w. By selecting a checklist from the list, a summary of each question and the answer that was provided will be shown as demonstrated in FIG. 2x. Selecting one of the checklist items will present the question to the user again so that the details of the answer (including notes and corrective actions) can be reviewed and/or modified.

At the completion of all of the measurements to be taken and other reporting done, the user uploads the data from the PDA to the database server where it is stored for later data analysis. The HACCP administrator or other person desiring to evaluate the data can review the data, search for problems, and take corrective action.

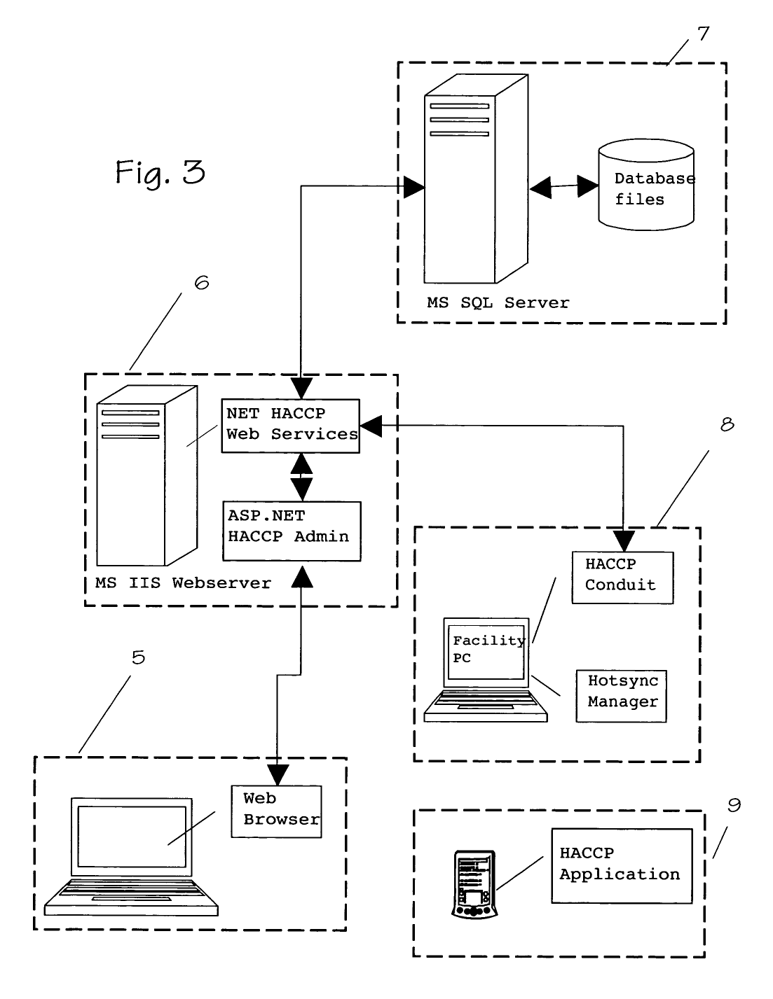

FIG. 3 shows an overview of one embodiment of the HACCP system described above, comprising a HACCP administrator computer 5, a system server 6, a database server 7, at least one Restaurant computer 8, and at least one personal digital assistant (PDA) 9.

The HACCP administrator 5 is a client who communicates with the system server 6 via the Internet. The HACCP administrator client connects with the system server from any personal computer or other computer via a web browser.

The system server 6 provides various functions, including a web-based user interface that provides the user access to the HACCP system without requiring individual software installations on each restaurant computer 8. Wizard-based interfaces are provided using a standard web browser on any personal computer to configure all aspects of the HACCP system across even the largest organization. The Web-based software can be configured to add company logo information according to the company's preference. The system server 6 components are industry standard commercial off the shelf applications such as Microsoft IIS, Microsoft SQL server, and Crystal Reports. Specific hardware requirements are dependent upon these applications and the size of the organization. The server consists of web pages and services running under the industry standard Microsoft IIS web server. The server communicates with web browsers and the PDAs using standard http protocols to avoid issues associated with corporate firewalls.

The HACCP software works with other applications so that reports can be automatically e-mailed. Custom analysis can be performed on the IQ HACCP with common applications such as Crystal Reports™ and Business Objects™.

The HACCP software can easily add or modify the HACCP checklists, critical limits, or corrective actions. When the HACCP system administrator revises any of the established parameters, the change is communicated instantly across the web to the entire organization, thus appearing at each restaurant location upon the next synchronization.

The central database server 7 acts as the central repository of information for the entire HACCP system. Microsoft's SQL Server or other database platforms will be used for the database server. All access to the database will be exposed as object invocations and methods in order to encapsulate all of the database specific functionality. The central database server and the system server may be combined or separate, and in one location or different locations.

The restaurant computers 8 are clients who communicate with the system server 6 via the Internet. The restaurant PC software is based on the Microsoft.NET platform. For some PDAs synchronization software that comes with the PDA must be loaded onto the restaurant PCs to integrate with the IQ HACCP system on the PDA. For example, HotSync manager is a Windows based application delivered with Palm Desktop that provides the synchronization capabilities required for PDA operation.

The HACCP system includes a custom conduit, when required, for the HotSync manager that will be used to communicate the data between the HACCP application on the PDA and the central database. Since this software is a conduit of the HotSync manager, it will have to be installed on each machine that is used for synchronizing a PDA. Not all PDA operating systems will require the conduit. In order to assist with the installation, this software will be packaged in a way to allow it to be distributed to clients from a website. Web services are used by the custom conduit for communication. These services run on the web server and provide XML interfaces to transfer information to and from the database.

The PDA device 9 can be any PDA such as the Palm, Dell Axim, Hewlett-Packard/Compaq ipaq, etc. The IQ HACCP software is loaded on the PDAs, but it can be downloaded off the Internet. The PDA software will be compliant with nearly every Palm OS and PocketPC based PDA on the market. The temperature probe is also designed to be compatible with nearly all PDAs as well. The cable assembly which connects the temperature probe to the PDA can be changed to accommodate the connector requirements of different PDAs.

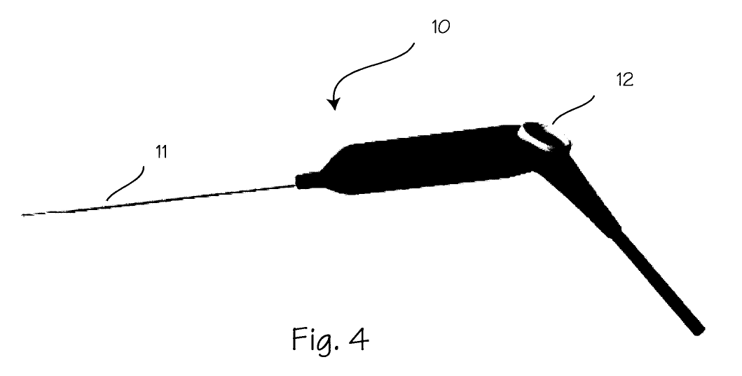

FIG. 4 shows a temperature probe 10, provided for attachment to the user's PDA. The temperature probe 10 is a universal temperature probe that fits many different types of PDAs. The temperature data probe attaches directly to the serial port of a PDA, tablet PC, laptop or desktop PC. The stainless steel tip 11 can be inserted directly into food products. The temperature probe allows direct temperature input into the PDA, which reduces human-related error due to manual temperature input. Embedded within the temperature probe is a ID tag reader interface 12 for reading the data from ID tags and data loggers mounted throughout the HACCP system. The ID tag reader feeds the data from the ID tags and data loggers directly into the PDA.

In a franchised food service organization comprising a franchiser and a plurality of franchisees, the method of implementing HACCP process and control can further require that the database be controlled by the franchisor (serving the HACCP administrator function) and that the data acquisition systems be purchased, controlled, and maintained by the franchisees. This also applies to organizations where each food service establishment within the organization has compartmentalized budgets, and wherein each food service establishment may be tasked with purchase control and maintenance of the data acquisition systems in order to address these compartmentalized budgets. Purchase, control and maintenance of the data acquisition systems, including PDA's, probes and applicable software and/or software licenses is thereby distributed over a number of discreet budgets or organizations.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A system for implementing HACCP process and control in an organization operating numerous restaurants, wherein each restaurant is managed by a manager and employs food service workers, wherein the organization employs a HACCP administrator tasked with establishing parameters reflecting the organization's HACCP goals, said system comprising:
means for entering various HACCP parameters into a database;
numerous data acquisition systems dispersed at the numerous restaurants, for use by food service workers, said data acquisition systems comprising PDAs;
means for communicating entered HACCP parameters to the PDAs via the internet; and
software installed on the PDAs for interactive use of the PDAs by the food service workers, said software providing operability to the PDA to accomplish the following functions:
receive data input from the food service worker regarding various measured or observed conditions relevant to the HACCP parameters; and
communicate the inputted data from the PDA via the internet to the database accessible to the HACCP administrator from a central location.

2. The system of claim 1, further comprising;
means for limiting entry of HACCP parameters to the HACCP administrator; and
means for accepting input from the restaurant managers regarding applicability of various HACCP parameters to activities specific to a particular restaurant.

3. The system of claim 1, further comprising;
means for limiting entry of HACCP parameters to the HACCP administrator; and
means for accepting input from the restaurant managers regarding applicability of various HACCP parameters specific to a particular restaurant and thereafter present parameters to food service workers within the particular restaurant with a customized collection of HACCP parameters.

4. The system of claim 1, 2 or 3, wherein the software installed in the PDA provides the further functions of;
conditionally prompting the food service worker for additional information pursuant to multi-step HACCP procedures;
conditionally prompting the food service worker for information regarding corrective actions if recorded data or observations are unacceptable; and
communicating the additional inputted data from the PDA to the database.

5. The system of claim 1, 2 or 3, wherein each data acquisition system further comprises:
a data logger reader proximate the PDA, said data logger reader operable to acquire data from a plurality of data loggers;
one or more data loggers fixed at locations within each restaurant, said locations corresponding to locations at which HACCP data must be taken;
wherein the PDA is programmed to prompt the food service worker, in the completion of a HACCP checklist requiring observation of physical conditions at a location in the restaurant, to read the data logger at the location at which the observation is to be performed, and thereby confirm that the food service worker is observing data relevant to the checklist, and, after receiving appropriate input from the data logger reader, accepting observation input in completion of the checklist.

6. The system of claim 1, 2 or 3, wherein each data acquisition system further comprises:
a temperature probe operably connected to the PDA for acquisition of temperature data;
a data logger reader proximate the temperature probe, said data logger reader operable to acquire data from a plurality of data loggers;
one or more data loggers fixed at locations within each restaurant, said locations corresponding to locations at which HACCP data must be taken;
wherein the PDA is programmed to prompt the food service worker, in the completion of a HACCP checklist, to read the data logger at the location at which the checklist is to be performed, and thereby confirm that the food service worker is acquiring temperature data relevant to the checklist, and, after receiving appropriate input from the data logger reader, accepting temperature input to the temperature probe in completion of the checklist.

7. The system of claim 6, wherein the temperature probe is characterized by an insertion portion adapted for insertion into food or other mass and a handle, and the data logger reader is fixed to the handle, spaced from the insertion portion.

8. The system of claim 1, 2, or 3 further comprising:
means for indicating exceptions to checklists and checklist items, including checklists not performed, checklist items not checked, and unacceptable measurements of HACCP parameters, to the HACCP administrator.

9. A method of implementing HACCP process and control in a franchised food service organization comprising a franchisor and a plurality of franchisees, said method comprising:
providing a system for implementing HACCP process and control in an organization operating numerous restaurants, wherein each restaurant is managed by a manager and employs food service workers, wherein the organization employs a HACCP administrator tasked with establishing parameters reflecting the organization's HACCP goals, said system comprising:
providing a database and means for entering various HACCP parameters into a database;
numerous data acquisition systems dispersed at the numerous restaurants, for use by food service workers, said data acquisition systems comprising PDAs;
means for communicating entered HACCP parameters to the PDAs; and
software installed on the PDAs for interactive use of the PDAs by the food service workers, said software providing operability to the PDA to accomplish the following functions:
receive data input from the food service worker regarding various measured or observed conditions relevant to the HACCP parameters; and
communicate the inputted data from the PDA to a database accessible to the HACCP administrator from a central location;
wherein;
the database is controlled by the franchiser; and
the data acquisition systems are purchased, controlled, and
maintained by the franchisees.
